(19) United States
(12) Patent Application Publication
(10) Pub. No.: US 2022/0328243 A1
(43) Pub. Date: Oct. 13, 2022

(54) MAGNETIC COMPONENT AND POWER CONVERTER

(71) Applicant: FUJI ELECTRIC CO., LTD., Kawasaki-shi (JP)

(72) Inventor: Akihiro HINO, Yokohama-city (JP)

(73) Assignee: FUJI ELECTRIC CO., LTD., Kawasaki-shi (JP)

(21) Appl. No.: 17/678,600

(22) Filed: Feb. 23, 2022

(30) Foreign Application Priority Data
Apr. 8, 2021 (JP) 2021-065600

(51) Int. Cl. H01F 27/36; H01F 27/26; H01F 27/28; H01F 27/32

(52) U.S. Cl. CPC H01F 27/366; H01F 27/263; H01F 27/2804; H01F 27/32; H01F 27/2876

(57) ABSTRACT

A core includes a first core part, a second core part, and a spacer. The spacer is between the first core part and the second core part. A board has an opening in which the first core part is inserted, and includes a wiring pattern that wraps around the opening. A magnetic shielding member covers all of the wiring pattern in a plan view of the board, and is insulated from the wiring pattern and the core.

### CROSS REFERENCE TO RELATED APPLICATION

This Application claims priority from Japanese Patent Application No. 2021-065600, filed Apr. 8, 2021, the entire contents of which are incorporated herein by reference.

### BACKGROUND

### Field of the Invention

The present disclosure relates to magnetic components, such as chokes and transformers, and relates to power converters that include such magnetic components.

### Description of Related Art

For example, magnetic components are mounted in power converters, such as DC/DC converters. Magnetic components mounted in power converters are desirably thin and compact. In order to make magnetic components thinner and more compact, planar coils are generally used to comprise the magnetic components, as disclosed in Patent Document 1 (Japanese Patent Application Laid-Open Publication No. 2016-213383). The winding of a planar coil is formed by the wiring pattern of the board.

In some cases, a spacer may be provided in the core of a magnetic component in order to make the inductance of the magnetic component constant. Although a spacer in the core can make the inductance constant, various problems may occur due to leakage of magnetic flux from the spacer. For example, in magnetic components using planar coils, eddy currents flow in the wiring patterns when the wiring pattern forming the winding and the leakage magnetic flux from the spacer intersect. When eddy currents flow in the wiring pattern, the temperature of the wiring pattern rises due to the Joule heat of eddy currents. When the temperature of the wiring pattern rises, the temperature of the board on which the wiring pattern is installed may rise and losses in the wiring pattern increase.

Patent Document 2 (Japanese Patent Application Laid-Open Publication No. 2015-61361) discloses a technique to prevent leakage of magnetic flux from a transformer mounted in a power converter from intersecting a circuit board mounted with a control circuit, or the like that controls the operation of the power converter. In the technique disclosed in Patent Document 2, positioning the circuit board so that the axial direction of the primary and secondary coils of the transformer is orthogonal to the normal direction of the circuit board prevents magnetic flux leaking from the transformer intersecting the circuit board.

With the technique disclosed in Patent Document 2, the intersection between the circuit board, which is separate from the coil, and the leakage magnetic flux is avoided. However, in a planar coil, the winding is formed by the wiring pattern on the board, so that the winding, i.e., the coil and the board are unitary. In a planar coil, in which the coil and the board unitary, the axial direction of the coil cannot be orthogonal to the normal direction of the board. For this reason, the technique disclosed in Patent Document 2 cannot be used to avoid the intersection between the 1 magnetic flux leaking from the spacer and the board in a planar coil. Increasing the distance between the spacer and the board on which the winding is formed decreases leaking magnetic flux intersecting the wiring pattern of the board. However, increasing the distance between the board and the spacer is not compatible with making magnetic components thinner.

### SUMMARY

An object, according to the present disclosure, which was made in consideration of the aforementioned circumstances, is to provide a technique for allowing making a magnetic component, in which a spacer is provided in the core and a winding is formed by a wiring pattern, thinner, and at the same time reducing leaking of magnetic flux intersecting the wiring pattern.

A magnetic component according to one aspect of the present disclosure includes: a core made of a soft magnetic material, the core including: a first core part; a second core part; and a spacer between the first core part and the second core part; a board that has a first opening in which the first core part is inserted; and a magnetic shielding member that is configured to shield against magnetism, and has a second opening in which the first core part is inserted, in which the board includes a first wiring pattern that wraps around the first opening, and in which the magnetic shielding member covers a part or all of the wiring pattern in a plan view of the board, and is insulated from the wiring pattern and the core.

A magnetic component according to one aspect of the present disclosure includes: a core made of a soft magnetic material, the core including: a first core part; a second core part; and a spacer between the first core part and the second core part; a board that has a first opening in which the first core part is inserted, in which the board includes: a first wiring layer that includes a first wiring pattern that wraps around the first opening, and a layer that is insulated from the first wiring layer, and is located closer to the spacer than the first wiring layer, and in which the layer includes a magnetic shielding member that is configured to shield against magnetism, covers a part or all of the wiring pattern in a plan view of the board, and is insulated from the core.

A power converter according to one aspect of the present disclosure includes a magnetic component according to any of the aforementioned aspects.

### BRIEF DESCRIPTION OF THE DRAWINGS

FIG. 1 is a perspective view of a magnetic component 1A according to the first embodiment.

FIG. 2 is a cross-sectional view of the magnetic component 1A.

FIG. 3 is an exploded view of the magnetic component 1A.

FIG. 4 shows an example of a wiring pattern 34 in the magnetic component 1A.

FIG. 5 is a perspective view of a magnetic component 1B according to the second embodiment.

FIG. 6 is a cross-sectional view of the magnetic component 1B.

FIG. 7 is a perspective view of a magnetic component 1C according to the third embodiment.

FIG. 8 is a cross-sectional view of the magnetic component 1C.

FIG. 9 shows an example of a wiring pattern 34 in the magnetic component 1C.

FIG. 10 shows an example of a wiring pattern 36 in the magnetic component 1C.

FIG. 11 is a perspective view of a magnetic component 1D according to the fourth embodiment.

FIG. 12 is a cross-sectional view of the magnetic component 1D.

FIG. 13 shows an example of a wiring pattern 34 in the magnetic component 1D.

FIG. 14 shows an example of a wiring pattern 36 in the magnetic component 1D.

FIG. 15 is a configuration diagram of a magnetic component 1E according to the fifth embodiment.

FIG. 16 is a configuration diagram of a magnetic component 1F according to the sixth embodiment.

FIG. 17 is a configuration diagram of a magnetic component 1G according to the seventh embodiment.

### DESCRIPTION OF THE EMBODIMENTS

### 1. First Embodiment

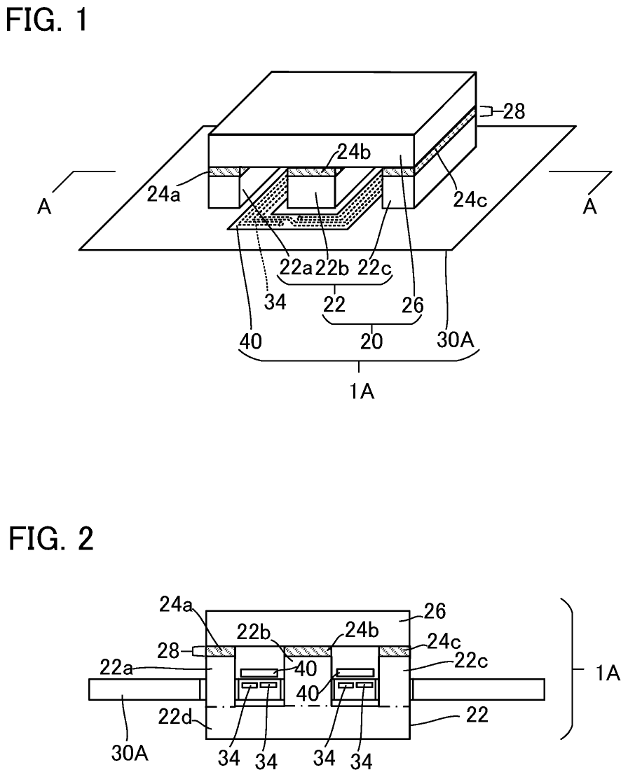

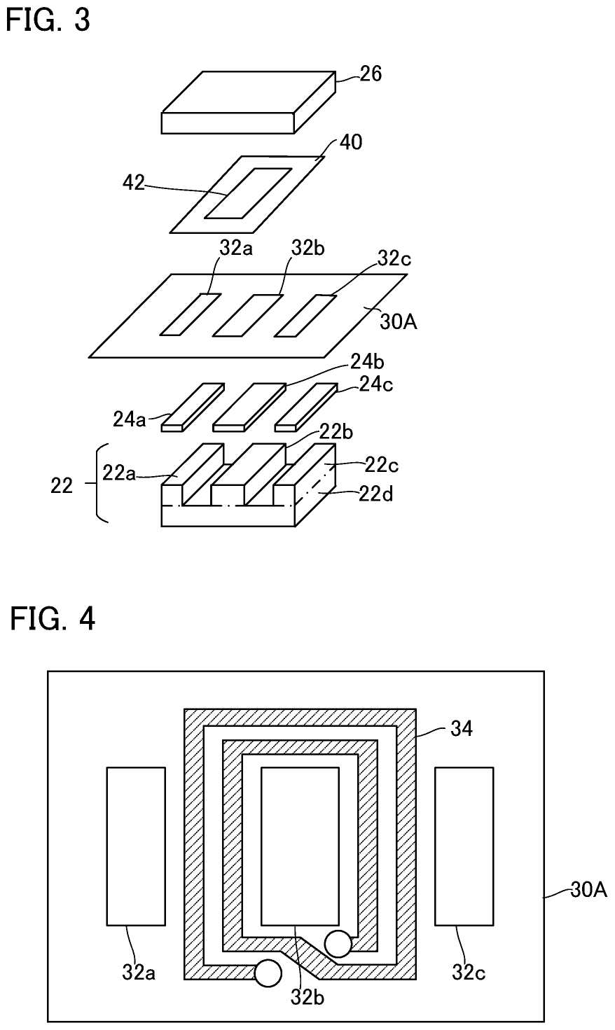

FIG. 1 is a perspective view of a magnetic component 1A according to the first embodiment according to the present disclosure. FIG. 2 shows a cross-section of the magnetic component 1A taken along line A-A shown in FIG. 1. FIG. 3 is an exploded view of the magnetic component 1A. As shown in FIGS. 1, 2 and 3, the magnetic component 1A includes a core 20, a board 30A, and a magnetic shielding member 40. The magnetic component 1A is a choke. The magnetic component 1A is mounted in a power converter, such as a DC/DC converter.

The core 20 includes a first core part 22 and a second core part 26. The first core part 22 and the second core part 26 are made of a soft magnetic material. In this embodiment, the first core part 22 and the second core part 26 are made of ferrite. As shown in FIG. 2, the cross section of the first core part 22, which is cut by a plane along line A-A, is E-shaped. As shown in FIGS. 2 and 3, the first core part 22 includes a first member 22d that is flat, a second member 22a, a third member 22b, and a fourth member 22c. The dash-dot lines in FIGS. 2 and 3 each represent the boundary between the first member 22d and each of the second member 22a, third member 22b, and fourth member 22c. As shown in FIGS. 2 and 3, each of the second member 22a, third member 22b, and fourth member 22c has a wall-like shape, and rises from the first member 22d. As shown in FIG. 2, the cross section of the second core part 26, which is cut by a plane along line A-A, is I-shaped. In other words, the core 20 is a so-called E-I core.

As shown in FIGS. 1, 2, and 3, in this embodiment, the first core part 22 and the second core part 26 are positioned such that they sandwich the plate member 24a, the plate member 24b, and the plate member 24c. Specifically, the plate member 24a is disposed between the second core part 26 and the second member 22a. A plate member 24b is disposed between the second core part 26 and the third member 22b. A plate member 24c is disposed between the second core part 26 and the fourth member 22c. The plate members 24a, 24b, and 24c are each made of non-magnetic material. The plate member 24a, plate member 24b, and plate member 24c each have the same thickness in the direction from the first core part 22 to the second core part 26. The first core part 22 and the second core part 26 are positioned such that they sandwich the plate member 24a, plate member 24b, and plate member 24c. Such an arrangement means that a spacer 28 having a certain width is provided in the core 20. Such a spacer 28 enables magnetic saturation that occurs in the core 20 to be reduced, as a result of which the inductance of the magnetic component 1A is constant. The winding in the magnetic component 1A is wound on the third member 22b of the core 20.

The board 30A is, for example, a printed circuit board. As shown in FIG. 3, the board 30A is board-shaped, and includes openings 32a, 32b, and 32c. The second member 22a of the first core part 22 is inserted in the opening 32a. The third member 22b of the first core part 22 is inserted in the opening 32b. The fourth member 22c of the first core part 22 is inserted in the opening 32c. Furthermore, on the board 30A is a wiring pattern 34 that wraps around the opening 32b. FIG. 4 shows an example of the wiring pattern 34. In FIG. 4, the wiring pattern 34 is represented by the hatched area. The wiring pattern 34 acts as a winding that winds the third member 22b of the core 20. In other words, the magnetic component 1A is constructed using a planar coil.

The magnetic shielding member 40 is plate-shaped, and is made of a conductive material, such as copper. As shown in FIG. 3, the magnetic shielding member 40 includes an opening 42. The third member 22b of the first core part 22 is inserted in the opening 42.

As shown in FIG. 1, the magnetic shielding member 40 is laid over the board 30A. In a plan view of the board 30A overlaid by the magnetic shielding member 40, the magnetic shielding member 40 is positioned so as to cover the entire wiring pattern 34, that is, the area from the innermost periphery to the outermost periphery of the wiring pattern 34. A plan view of the board 30A is a view of the board 30A from the normal direction of the board 30A. The magnetic shielding member 40 is attached to the board 30A using a non-conductive adhesive or the like so as to cover all of the wiring pattern 34. In other words, the magnetic shielding member 40 is insulated from the wiring pattern 34.

Since the magnetic shielding member 40 according to this embodiment is made of a conductor, the magnetic shielding member 40 shields against magnetism. Specifically, when magnetic flux leaking from the spacer 28 and the magnetic shielding member 40 intersect, eddy currents are induced in the magnetic shielding member 40. As shown in FIG. 3, in this embodiment, in a plan view of the magnetic shielding member 40, the shape of the opening 42 is a form with no depressions. A plan view of the magnetic shielding member 40 refers to a view of the magnetic shielding member 40 from the normal direction to the magnetic shielding member 40. A form with no depressions refers to one in which all points on a line segment connecting any two points on the contour line of the figure are located within or on the contour line of the form. If there is a depression in the shape of the opening 42 in a plan view of the magnetic shielding member 40, eddy currents, which do not flow across the depression, will not flow easily around the opening 42. As shown in FIG. 3, in a plan view of the magnetic shielding member 40 in this embodiment, the shape of the opening 42 has no depressions, so that the induction of eddy currents is not hindered around the opening 42 of the magnetic shielding member 40.

The eddy currents flowing in the magnetic shielding member 40 due to magnetic flux leaking from the spacer 28 intersecting the magnetic shielding member 40 generates magnetic flux in a direction in which the leaking magnetic flux is cancelled. Consequently, in the magnetic component 1A, two types of magnetic fluxes intersect the wiring pattern 34. (i) One of the two is a magnetic flux leaking from the spacer 28. (ii) The other is a magnetic flux generated by eddy currents. These eddy currents are induced in the magnetic shielding member 40 by leaking magnetic flux labeled (i). As a result, the magnetic flux intersecting the wiring pattern 34 is reduced compared to a case without the magnetic shielding member 40. Since eddy currents are induced in the magnetic shielding member 40 according to the magnetic flux leaking from the spacer 28, the temperature of the magnetic shielding member 40 rises due to Joule heat from these eddy currents. However, the leaking magnetic flux that intersects the magnetic shielding member 40 is some of the magnetic flux leaking from the spacer 28, specifically, the flux that intersects the wiring pattern 34. For this reason, the temperature rise of the magnetic shielding member 40 caused by the magnetic flux leaking from the spacer 28 is limited.

With the magnetic component 1A according to this embodiment, the magnetic flux that intersects the wiring pattern 34 is reduced compared to the case without the magnetic shielding member 40, thereby suppressing temperature increase in the board 30A and increase in losses in the wiring pattern 34 caused by magnetic flux leaking from the spacer 28. In the magnetic component 1A according to this embodiment, the distance between the spacer 28 and the wiring pattern 34 does not need to be increased, because the effect of the magnetic flux leaking from the spacer 28 can be mitigated by providing the magnetic shielding member 40. Since there is no need to increase the distance between the spacer 28 and the wiring pattern 34, the magnetic component 1A can be made thinner. Thus, this embodiment allows the possibility of making the magnetic component 1A thinner, and at the same time, reducing the leaking magnetic flux that intersects the wiring pattern 34. The magnetic shielding member 40 may not necessarily be in close contact with the wiring pattern 34. In an aspect in which there is a spacer between the magnetic shielding member 40 and the wiring pattern 34, the wiring pattern 34, which acts as a winding, can be efficiently cooled by sending cooling fluid such as air through the spacer using a cooling fan, for example.

### 2. Second Embodiment

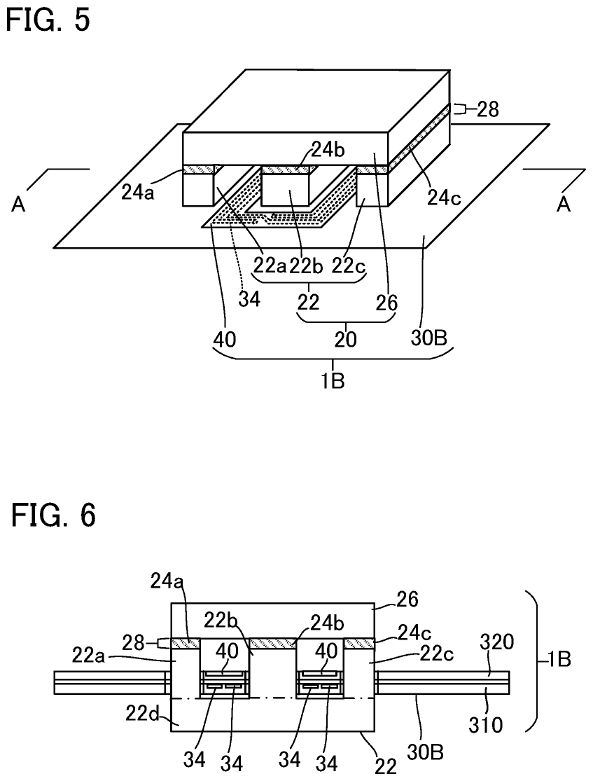

FIG. 5 is a perspective view of a magnetic component 1B according to the second embodiment according to the present disclosure. FIG. 6 shows a cross-section of the magnetic component 1B taken along line A-A shown in FIG. 5. The magnetic component 1B according to this embodiment is a choke similar to the magnetic component 1A. The magnetic component 1B is mounted in a power converter similar to the magnetic component 1A.

The magnetic component 1B includes a board 30B instead of a board 30A. In this regard, the configuration of the magnetic component 1B differs from that of the magnetic component 1A. The board 30B is a printed circuit board, similar to the board 30A. The board 30B is board-shaped, similar to the board 30A. Although detailed illustrations are omitted in FIGS. 5 and 6, the board 30B has openings 32a, 32b, and 32c, similar to the board 30A. Furthermore, the board 30B includes a wiring pattern 34 that wraps around the opening 32b, similar to the board 30A. The board 30B according to this embodiment differs from the board 30A in that it includes a wiring layer 310 and a layer 320 as shown in FIG. 6. The wiring pattern 34 is provided in the wiring layer 310. The layer 320 is insulated from the wiring layer 310. The layer 320 is located closer to the spacer 28 than the wiring layer 310. The layer 320 includes a magnetic shielding member 40 that entirely covers the wiring pattern 34 in a plan view of the board 30B. A plan view of the board 30B refers to a view of the board 30B from the normal direction to the board 30B.

As compared to a case without the magnetic shielding member 40, the magnetic component 1B according to this embodiment reduces magnetic flux intersecting the wiring pattern 34, thereby suppressing increase in temperature of the board 30B and increase in losses in the wiring pattern 34 caused by the magnetic flux leaking from the spacer 28. In the magnetic component 1B according to this embodiment, the distance between the spacer 28 and the wiring pattern 34 does not need to be increased, because the effect of the magnetic flux leaking from the spacer 28 can be mitigated by providing the magnetic shielding member 40. Thus, this embodiment allows the possibility of making the magnetic component 1B thinner, and at the same time reducing the leaking magnetic flux that intersects the wiring pattern 34.

### 3. Third Embodiment

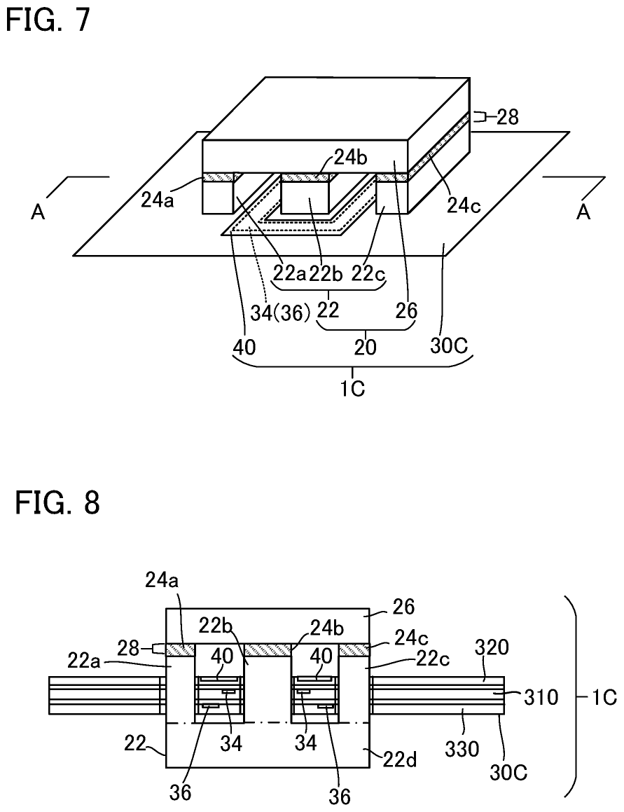

FIG. 7 is a perspective view of a magnetic component 1C according to the third embodiment according to the present disclosure. FIG. 8 shows a cross-section of the magnetic component 1C taken along line A-A shown in FIG. 7. The magnetic component 1C according to this embodiment is a choke, similar to the magnetic components 1A and 1B. The magnetic component 1C is mounted in a power converter, similar to the magnetic components 1A and 1B.

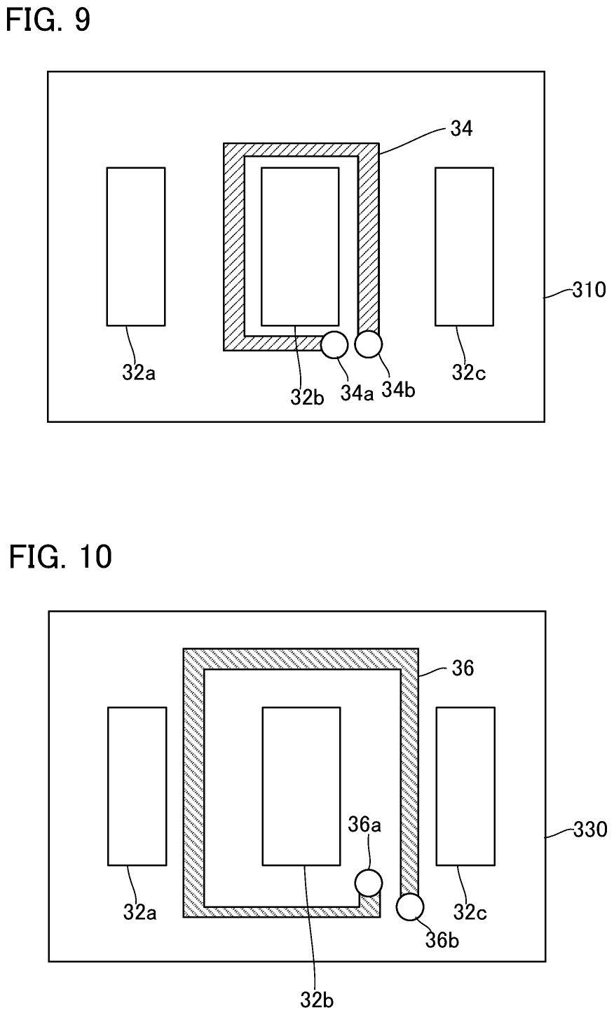

The magnetic component 1C includes a board 30C instead of a board 30B. In this regard, the configuration of the magnetic component 1C differs from that of the magnetic component 1B. Although detailed illustrations are omitted in FIGS. 7 and 8, the board 30C includes openings 32a, 32b, and 32c. In this regard, the board 30C is the same as the board 30B. The board 30C includes the wiring layer 310 and the layer 320. In this regard, the board 30C is the same as the board 30B. However, the board 30C differs from the board 30B in the following: (i) the board 30C includes a wiring layer 330 that is located farther from the spacer 28 than the wiring layer 310; and (ii) the wiring layer 330 includes a wiring pattern 36 electrically connected to the wiring pattern 34 and wraps around the opening 32b. The magnetic component 1C includes a winding that is formed by the wiring pattern 34 and the wiring pattern 36. FIG. 9 shows an example of the wiring pattern 34 according to this embodiment. FIG. 10 shows an example of the wiring pattern 36 according to this embodiment. In this embodiment, a winding from a terminal 34a to a terminal 36b is formed by electrically connecting the terminal 34b to the terminal 36a. In the winding from the terminal 34a to the terminal 36b, the wiring pattern 34 is the innermost winding and the wiring pattern 36 is the outermost winding. As shown in FIGS. 7 and 8, in this embodiment, the magnetic shielding member 40 is provided to cover the wiring pattern 34 and the wiring pattern 36.

The magnetic component 1C according to this embodiment, in which the magnetic flux intersecting the wiring patterns 34 and 36 is reduced compare to a case without the magnetic shielding member 40, also suppresses rise in temperature of the board 30C and increase in losses in the wiring patterns 34 and 36 caused by magnetic flux leaking from the spacer 28. In the magnetic component 1C according to this embodiment, the distance between the spacer 28 and the wiring pattern 34 does not need to be increased, because the effect of the magnetic flux leaking from the spacer 28 can be mitigated by providing the magnetic shielding member 40. Thus, this embodiment allows the possibility of making the magnetic component 1C thinner, and at the same time reducing the leaking magnetic flux that intersects the wiring patterns 34 and 36.

### 4. Fourth Embodiment

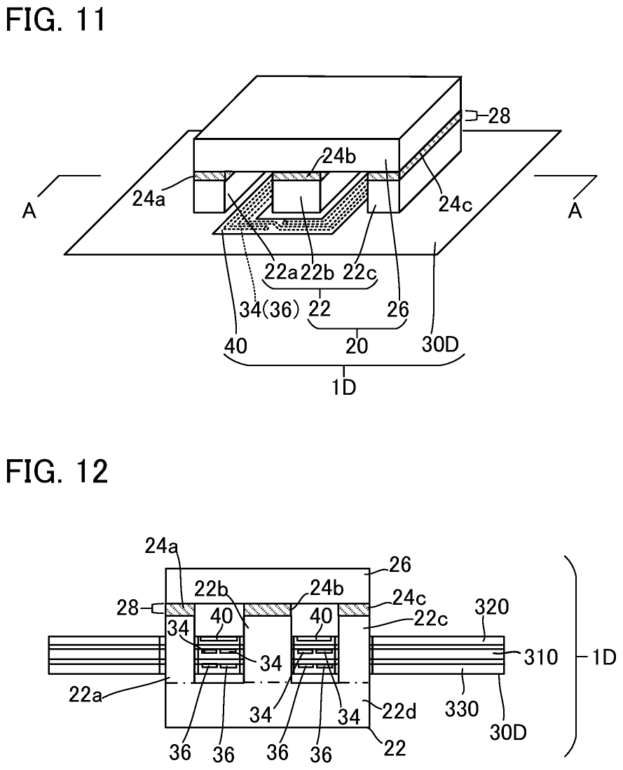

FIG. 11 is a perspective view of a magnetic component 1D according to the fourth embodiment according to the present disclosure. FIG. 12 shows a cross-section of the magnetic component 1D taken along line A-A shown in FIG. 11. The magnetic component 1D includes a board 30D instead of a board 30C. In this regard, the configuration of the magnetic component 1D differs from that of the magnetic component 1C. The board 30D has openings 32a, 32b, and 32c, and includes wiring layers 310 and 330, and a layer 320. In this regard, the board 30D is the same as the board 30C. However, the board 30D differs from the board 30C in that the wiring pattern 34 formed in the wiring layer 310 and the wiring pattern 36 formed in the wiring layer 330 are not electrically connected to each other.

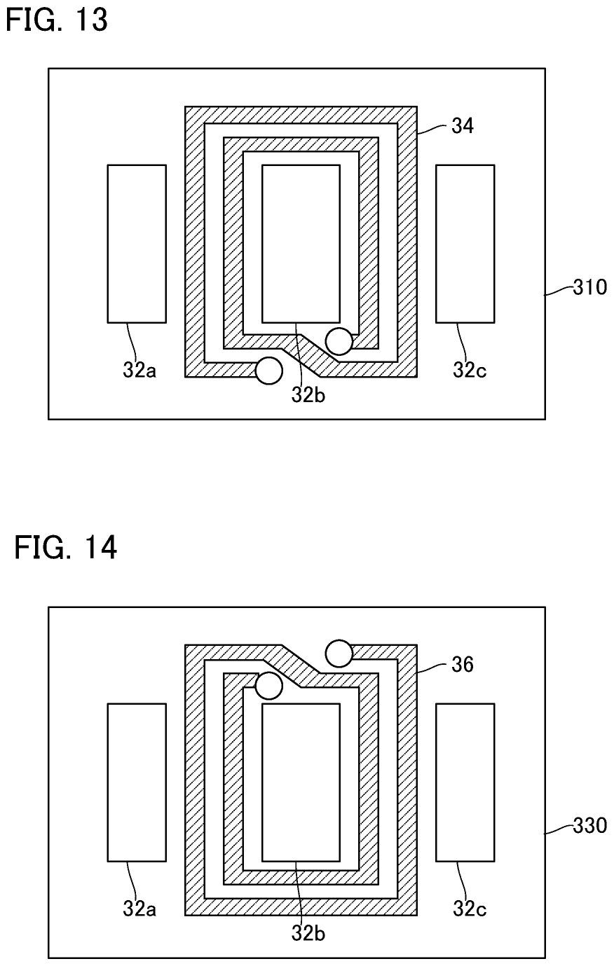

FIG. 13 shows an example of the wiring pattern 34 according to this embodiment. FIG. 14 shows an example of a wiring pattern 36 according to this embodiment. In the magnetic component 1D, the wiring pattern 34 acts as a first coil. In the magnetic component 1D, the wiring pattern 36 acts as a second coil that is separate from the first coil. For example, when the first coil is used as the primary coil and the second coil is used as the secondary coil, the magnetic component 1D acts as a transformer. The magnetic component 1D is mounted on the power converter like the magnetic components 1A, 1B, and 1C.

The magnetic component 1D according to this embodiment, in which the magnetic flux intersecting the wiring patterns 34 and 36 is reduced compared to a case without the magnetic shielding member 40, also suppresses rise in temperature of the board 30D and increase in losses in the wiring patterns 34 and 36 caused by magnetic flux leaking from the spacer 28. In the magnetic component 1D according to this embodiment, the distance between the spacer 28 and the wiring pattern 34 does not need to be increased, because the effect of the magnetic flux leaking from the spacer 28 can be mitigated by providing the magnetic shielding member 40. Thus, this embodiment allows the possibility of making the magnetic component 1D thinner, and at the same time reducing leaking magnetic flux that intersects the wiring patterns 34 and 36. In this embodiment, two wiring layers are provided separately. One of the two is the wiring layer on which the wiring pattern 34, which acts as the first coil, is provided. The other is the wiring layer on which the wiring pattern 36, which acts as the second coil, is provided. However, the wiring pattern 34 and the wiring pattern 36 may be provided on one wiring layer. Specifically, the wiring pattern 34 may be formed in the wiring layer 310 as shown in FIG. 9, and the wiring pattern 36 may be formed outside the wiring pattern 34 in the wiring layer 310 as shown in FIG. 10.

### 5. Fifth Embodiment

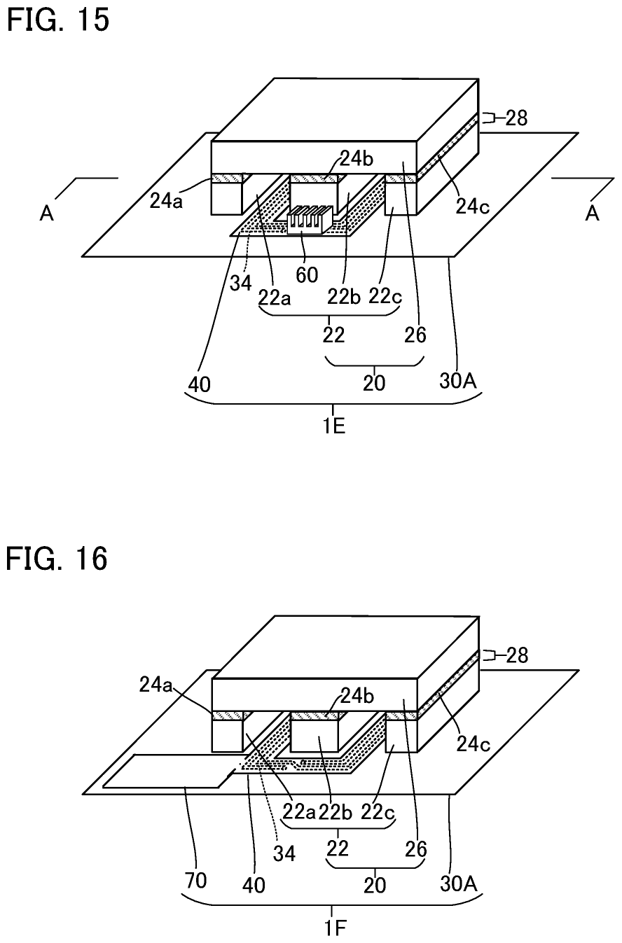

FIG. 15 is a perspective view of a magnetic component 1E according to the fifth embodiment according to the present disclosure. The magnetic component 1E in this embodiment is a choke, similar to the magnetic component 1A. The magnetic component 1E is mounted in a power converter, similar to the magnetic component 1A. The magnetic component 1E includes a heat sink 60. In this regard, the magnetic component 1E differs from the magnetic component 1A. The heat sink 60 is an air-cooling structure. The heat sink 60 acts as a cooling structure that cools the magnetic shielding member 40. The heat sink 60 is fixed to the magnetic shielding member 40 with a thermally conductive adhesive or solder. Providing the heat sink 60 makes it possible to efficiently cool the magnetic shielding member 40 in which temperature rises due to flow of eddy currents corresponding to the magnetic flux leaking from the spacer 28. Thus, similar to the first embodiment, this embodiment allows the possibility of making the magnetic component 1E thinner, and at the same time reducing the leaking magnetic flux that intersects the wiring pattern 34.

### 6. Sixth Embodiment

FIG. 16 is a perspective view of a magnetic component 1F according to the sixth embodiment according to the present disclosure. The magnetic component 1F in this embodiment is a choke, similar to the magnetic component 1A. The magnetic component 1F is mounted in a power converter, similar to the magnetic component 1A. The magnetic component 1F includes a plate member 70. In this regard, the magnetic component 1F differs from the magnetic component 1A. The plate member 70 is integral with the magnetic shielding member 40 through a conductor or the like. The dot-and-dash line in FIG. 16 indicates the boundary between the magnetic shielding member 40 and the plate member 70. Similar to the heat sink 60 according to the fifth embodiment, the plate member 70 is an air-cooling structure configured to dissipate heat. The plate member 70 acts as a cooling structure that cools the magnetic shielding member 40. This embodiment makes it possible to efficiently cool the magnetic shielding member 40. As in the first embodiment, this embodiment allows the possibility of making the magnetic component 1F thinner, and the same time reducing the leaking magnetic flux that intersects the wiring pattern 34.

### 7. Seventh Embodiment

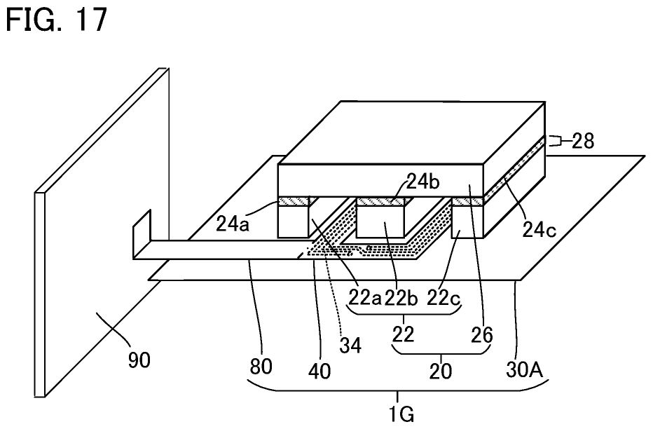

FIG. 17 is a perspective view of a magnetic component 1G according to the seventh embodiment according to the present disclosure. The magnetic component 1G in this embodiment is a choke, similar to the magnetic component 1A. The magnetic component 1G is mounted in a power converter, similar to the magnetic component 1A. In FIG. 17, the reference numeral 90 indicates the power converter housing, in which the magnetic component 1G is mounted. The housing 90 is made of a metal such as iron or aluminum, i.e., a material having high thermoelectric conductivity. The magnetic component 1G includes a heat conduction path 80 that thermally connects the magnetic shielding member 40 to the housing 90. In this regard, the magnetic component 1G differs from the magnetic component 1A. The heat conduction path 80 is integral with the magnetic shielding member 40 by a conductor or the like. The dot-and-dash line in FIG. 17 represents the boundary between the magnetic shielding member 40 and the heat conduction path 80. In this embodiment, the heat of the magnetic shielding member 40 is transferred to the housing 90 through the heat conduction path 80. In this embodiment, the housing 90 acts as an air-cooling structure configured to dissipate heat, similar to the heat sink 60 according to the fifth embodiment and the plate member 70 according to the sixth embodiment. In this embodiment, the magnetic shielding member 40 is cooled by transferring heat to the housing 90 through the heat conduction path 80. In other words, the heat conduction path 80 acts as a cooling structure that cools the magnetic shielding member 40. This embodiment makes it possible to efficiently cool the magnetic shielding member 40. As in the first embodiment, this embodiment allows the possibility of making the magnetic component 1G thinner, and at the same time reducing the leaking magnetic flux that intersects the wiring pattern 34.

### 8. Modifications

The aforementioned embodiments may be modified in the following manner. The magnetic components 1A, 1B, 1C, 1D, 1E, 1F, and 1G may be collectively referred to as magnetic component 1 in the following description.

(1) The magnetic shielding member 40 according to each of the aforementioned embodiments entirely covers the wiring pattern forming the winding. However, since the effect of magnetic flux leaking from the spacer 28 is less from the innermost periphery toward the outermost periphery of the wiring pattern forming the winding, the magnetic shielding member 40 may cover a part of the wiring pattern 34 forming the winding, specifically, an area including the innermost periphery and excluding the outermost periphery.

(2) The magnetic component 1 may be manufactured or be sold separately. The power converter including the magnetic component 1 may be manufactured or be sold separately. The device mounted in the magnetic component 1 is not necessarily a power converter. The magnetic component 1 may be mounted in an in-vehicle charger. Alternatively, the magnetic component 1 may be mounted in chargers for charging home game consoles, stationary information terminals or portable information terminals. Alternatively, the magnetic component 1 may be mounted in power supply circuits of home appliances. The following (i) to (iii) may be manufactured or be sold separately: (i) in-vehicle chargers including the magnetic component 1; (ii) battery chargers including the magnetic component 1; and (iii) power supply circuits including the magnetic component 1.

(3) The materials for the first core part 22 and the second core part 26 may be soft magnetic materials, and they may be conductive. One example of a material having soft magnetic properties and electrical conductivity is iron. When the first core part 22 and the second core part 26 are made of conductive materials, the core 20 is insulated from the wiring pattern that acts as the winding and the magnetic shielding member 40. For this reason, in such a case, the surface of the core 20 may be covered with a non-conductive resin or the like.

(4) The magnetic shielding member 40, which is made of a conductor in each of the aforementioned embodiments, may be made of a soft magnetic material that is magnetized in a direction in which the magnetic flux leaking from the spacer 28 is reduced. This is because the magnetization of the magnetic shielding member 40 reduces the leaking magnetic flux that intersects the wiring pattern 34. When the magnetic shielding member 40 is made of a soft magnetic material, the magnetic shielding member 40 does not need to be conductive.

### 9. Aspects to be Conceived from Embodiments and Modifications

The present disclosure is not limited to the aforementioned embodiments and modification, and can be achieved in various aspects without departing from its scope. The present disclosure can be achieved in the following aspect. The technical features in the aforementioned embodiments corresponding to the technical features in each of the following aspects can be switched or combined as appropriate to solve some or all of the problems according to the present disclosure, or to achieve some or all of the advantageous effects according to the present disclosure. If a certain technical feature is not described as essential herein, it may be omitted as appropriate.

A magnetic component 1A, 1E, 1F, or 1G according to an aspect according to the present disclosure includes a core 20 made of a soft magnetic material, a board 30A, and a magnetic shielding member 40 for shielding against magnetism. The core 20 includes a first core part 22 and a second core part 26. There is a spacer 28 between the first core part 22 and the second core part 26. The board 30A has an opening 32b in which the third member 22b of the first core part 22 is inserted. The opening 32b is an example of a first opening according to the present disclosure. The board 30A includes a wiring pattern 34 that wraps around the opening 32b. The magnetic shielding member 40 includes an opening 42 through which the third member 22b of the first core part 22 is inserted. The opening 42 is an example of a second opening according to the present disclosure. In a plan view of the board 30A, the magnetic shielding member 40 covers part or all of the wiring pattern 34. The magnetic shielding member 40 is insulated from the wiring pattern 34 and the core 20. With the magnetic component 1A, 1E, 1F, or 1G according to this aspect, leaking magnetic flux that intersects wiring pattern 34 can be reduced without increasing the distance between the spacer 28 and the wiring pattern 34. Hence, this aspect allows the possibility of making the magnetic component 1A, 1E, 1F, or 1G thinner, and at the same time reducing the leaking magnetic flux that intersects the wiring pattern 34.

A magnetic component 1B, 1C, or 1D according to an aspect according to the present disclosure includes: a core 20 that is made of a soft magnetic material, a board 30B, a board 30C, or a board 30D; and a magnetic shielding member 40 that shields against magnetism. The core 20 includes a first core part 22 and a second core part 26. There is a spacer 28 between the first core part 22 and the second core part 26. The spacer 28 has a certain width. The spacer 28 is plate-shaped, and is made of non-magnetic material. Specifically, the spacer 24 includes plate members 24a, 24b, and 24c. The boards 30B, 30C and 30D each have an opening 32b through which the first core part 22 is inserted. The boards 30B, 30C and 30D include a wiring layer 310 and a layer 320. The wiring layer 310 has a wiring pattern 34 that wraps around the opening 32b. The wiring layer 310 is an example of the first wiring layer according to the present disclosure. The wiring pattern 34 is an example of the first wiring pattern according to the present disclosure. The layer 320 is insulated from the wiring layer 310. The layer 320 is located closer to the spacer 28 than the wiring layer 310. In a plan view of the board 30B, 30C, or 30D, the layer 320 has a magnetic shielding member 40 that covers part or all of the wiring pattern 34. A plan view of the board 30C refers to a view of the board 30C from the direction normal to the board 30C. A plan view of the board 30D refers to a view of the board 30D from the direction normal to the board 30D. The magnetic shielding member 40 is insulated from the core 20 and shields against magnetism. With the magnetic component 1B, 1C, or 1D according to this aspect, leaking magnetic flux that intersects the wiring pattern 34 can be reduced without increasing the distance between the spacer 28 and the wiring pattern 34. Hence, this aspect allows the possibility of making the magnetic component 1B, 1C, or 1D thinner, and at the same time reducing leaking magnetic flux that intersects the wiring pattern 34.

In the aspect in which the magnetic shielding member 40 covers a part of the wiring pattern 34, the part of the wiring pattern 34 covered by the magnetic shielding member 40 may include the innermost periphery of the wiring pattern 34, and it does not have to include the outermost periphery of the wiring pattern 34. Since the effect of the magnetic flux leaking from the spacer 28 is smaller from the innermost periphery to the outermost periphery of the wiring pattern 34, this aspect makes it possible to mitigate the effects caused by magnetic flux leaking from the spacer 28 and intersecting with the wiring pattern 34, without covering the entire wiring pattern 34 with the magnetic shielding member 40.

A more preferred aspect of board 30C or 30D may include a wiring layer 330 that is located farther from the spacer 28 than the wiring layer 310. The wiring layer 330 is an example of a second wiring layer according to the present disclosure. In this aspect of board 30C, the wiring layer 330 may include a wiring pattern 36. The wiring pattern 36 is electrically connected to the wiring pattern 34, and wraps around the opening 32b. The wiring pattern 36 is an example of a second wiring pattern according to the present disclosure. In this aspect of board 30D, the wiring layer 330 may include a wiring pattern 36 that wraps around the opening 32b. The wiring pattern 34 may be the first coil, and the wiring pattern 36 may be the second coil.

A more preferred aspect of magnetic component 1 may further include a cooling structure that cools the magnetic shielding member 40. This aspect makes it possible to efficiently cool the magnetic shielding member 40 in which temperature increases due to the flow of eddy currents corresponding to the magnetic flux leaking from the spacer 28. In a further preferred aspect, if the housing 90 of the device mounted with the magnetic component 1 acts as an air-cooling structure that dissipates heat, the cooling structure may be a heat conduction path 80 thermally connecting the housing 90 to the magnetic shielding member 40. In this aspect, the magnetic shielding member 40 is cooled using the housing 90 of the device mounted with the magnetic component 1 as an air-cooling structure. In still another preferred aspect, the cooling structure may be an air-cooling structure configured to dissipate heat. If the cooling structure is an air-cooling structure, a specific example of the cooling structure is a heat sink 60 positioned so as to be in contact with the magnetic shielding member 40. In this aspect, the magnetic shielding member 40 is cooled using the heat sink 60 that is retrofitted to the magnetic shielding member 40. If the cooling structure is an air-cooling structure, another specific example of the cooling structure is a plate member 70 integral with the magnetic shielding member 40. In this aspect, the cooling structure for cooling the magnetic shielding member 40 can be formed integrally with the magnetic shielding member 40.

The power converter according to an aspect of the present disclosure includes a magnetic component 1, specifically any of the magnetic components 1A, 1B, 1C, 1D, 1E, 1F, and 1G. In this aspect, the power converter includes: the core 20 including the spacer 28; and the magnetic component 1 including a winding that is formed by the wiring pattern 34. Accordingly, this aspect allows the possibility of making the power converter thinner and at the same time reducing leaking magnetic flux that intersects the wiring pattern 34 in the magnetic component 1.

### DESCRIPTION OF REFERENCE SIGNS

1, 1A, 1B, 1C, 1D, 1E, 1F, 1G . . . magnetic component; 20 . . . core; 22 . . . first core part; 24a, 24b, 24c . . . plate member; 26 . . . second core part; 30A, 30B, 30C, 30D . . . board; 40 . . . magnetic shielding member; 34, 36 . . . wiring pattern; 60 . . . heat sink; 70 . . . plate member; 80 . . . heat conduction path; and 90 . . . housing

What is claimed is:

1. A magnetic component comprising:
a core made of a soft magnetic material, the core including:
a first core part;
a second core part; and
a spacer between the first core part and the second core part;
a board that has a first opening in which the first core part is inserted; and
a magnetic shielding member that is configured to shield against magnetism, and has a second opening in which the first core part is inserted,
wherein the board includes a first wiring pattern that wraps around the first opening, and
wherein the magnetic shielding member covers a part or all of the wiring pattern in a plan view of the board, and is insulated from the wiring pattern and the core.

2. The magnetic component according to claim 1,
wherein a part of the wiring pattern includes an innermost periphery of the wiring pattern, and excludes an outermost periphery of the wiring pattern.

3. A magnetic component comprising:
a core made of a soft magnetic material, the core including:
a first core part;
a second core part; and
a spacer between the first core part and the second core part;
a board that has a first opening in which the first core part is inserted, wherein the board includes:
a first wiring layer that includes a first wiring pattern that wraps around the first opening, and
a layer that is insulated from the first wiring layer, and is located closer to the spacer than the first wiring layer, and
wherein the layer includes a magnetic shielding member that is configured to shield against magnetism, covers a part or all of the wiring pattern in a plan view of the board, and is insulated from the core.

4. The magnetic component according to claim 3,
wherein a part of the first wiring pattern includes an innermost periphery of the first wiring pattern, and excludes an outermost periphery of the first wiring pattern.

5. The magnetic component according to claim 3,
wherein the board further includes a second wiring layer that is located farther from the spacer than the first wiring layer, and
wherein the second wiring layer includes a second wiring pattern that is electrically connected to the first wiring pattern, and wraps around the first opening.

6. The magnetic component according to claim 3,
wherein the board further includes a second wiring layer that is located farther from the spacer than the first wiring layer,
wherein the second wiring layer includes a second wiring pattern that wraps around the first opening,
wherein the first wiring pattern is a first coil, and
wherein the second wiring pattern is a second coil.

7. The magnetic component according to claim 1, further comprising a cooling structure configured to cool the magnetic shielding member.

8. The magnetic component according to claim 7,
wherein the cooling structure is a heat conduction path, and
wherein the heat conduction path is configured to thermally connect the magnetic shielding member to an air-cooling structure configured to dissipate heat.

9. The magnetic component according to claim 7,
wherein the cooling structure is an air-cooling structure configured to dissipate heat.

10. The magnetic component according to claim 9,
wherein the air-cooling structure is a heat sink that is in contact with the magnetic shielding member.

11. The magnetic component according to claim 9,
wherein the air-cooling structure is a plate member integral with the magnetic shielding member.

12. A power converter comprising:
a magnetic component, and
wherein the magnetic component includes:
a core made of a soft magnetic material, the core including:
a first core part;
a second core part; and
a spacer between the first core part and the second core part;
a board that has a first opening in which the first core part is inserted; and
a magnetic shielding member that is configured to shield against magnetism, and has a second opening in which the first core part is inserted,
wherein the board includes a first wiring pattern that wraps around the first opening, and
wherein the magnetic shielding member covers a part or all of the wiring pattern in a plan view of the board, and is insulated from the wiring pattern and the core.
